(19) United States
(12) Patent Application Publication
(10) Pub. No.: US 2020/0023808 A1
(43) Pub. Date: Jan. 23, 2020

(54) OCCUPANT RESTRAINT BELT WEBBING, SEAT BELT, AND SEAT BELT DEVICE

(71) Applicant: JOYSON SAFETY SYSTEMS JAPAN K.K., Tokyo (JP)

(72) Inventors: Hiroki TERAI, Shiga (JP); Sadayuki SHIMAZAKI, Shiga (JP)

(73) Assignee: JOYSON SAFETY SYSTEMS JAPAN K.K., Tokyo (JP)

(21) Appl. No.: 16/485,386

(22) PCT Filed: Jan. 29, 2018
(86) PCT No.: PCT/JP2018/002698

§ 371 Date: Aug. 12, 2019

(30) Foreign Application Priority Data
Feb. 27, 2017 (JP) 2017-035011

(51) Int. Cl. B60R 22/12

(52) U.S. Cl. CPC B60R 22/12; B60R 22/48

(57) ABSTRACT

An occupant restraint belt webbing forms a long occupant restraint belt to restrain a vehicle occupant, and includes a plurality of warp yarns and a plurality of weft yarns. The plurality of warp yarns and the plurality of weft yarns are woven so as to extend orthogonally to each other. The warp yarns or the weft yarns include an infrared light absorption yarn.

### TECHNICAL FIELD

The present invention relates to an occupant restraint belt webbing, a seat belt, and a seat belt device.

### BACKGROUND ART

Cameras have been used to image an occupant seated on a seat of a vehicle to detect a seating state and posture. For example, Patent Literature 1 (JP-A-2008-68742) discloses a seat belt device including a light emitting element which irradiates a belt fitted to an occupant with infrared light, an infrared light absorption unit provided on the belt, and a light receiving element which receives the reflected light from the belt. The infrared light absorption unit is made of black body markers, discriminates the region of the marker where reflected light of infrared light is not generated from the other regions where reflected light is generated, and obtains information on the worn state of the belt.

With respect to the markers as the infrared light absorption unit, Patent Literature 1 only describes that a plurality of markers are provided at equal intervals in the longitudinal direction of the belt, and does not describe a specific method for forming the markers on the belt.
Patent Literature 1: JP-A-2008-68742

### SUMMARY OF INVENTION

An object of the invention is to provide an occupant restraint belt webbing, a seat belt using the webbing, and a seat belt device using the webbing which have an infrared light absorption function so as to have a clear contrast between an infrared light absorption regions and the other regions when imaged by an infrared camera,

The occupant restraint belt webbing of the invention is an occupant restraint belt webbing forming a long occupant restraint belt to restrain a vehicle occupant, including a plurality of warp yarns and a plurality of weft yarns that are woven so as to extend orthogonally to each other, wherein the warp yarns or the weft yarns include an infrared light absorption yarn.

In one aspect of the invention, the infrared light absorption yarn is a filament yarn containing an infrared light absorption dye or an infrared light-absorbing pigment and made of polyester or nylon, and among the warp yarns and weft yarns, the yarns other than the infrared light absorption yarn are filament yarns made of polyester or nylon.

In one aspect of the invention, at least one of the plurality of warp yarns is the infrared light absorption yarn.

The seat belt of the invention is formed using the occupant restraint belt webbing of the invention.

The seat belt device of the invention includes a seat belt of the invention; a retractor that is configured to wind the seat belt; a buckle that is fixed to a vehicle; a tongue that is provided on the seat belt and that engages with the buckle; an irradiation unit that is configured to irradiate the seat belt with infrared light; and a light receiving unit that is configured to receive reflected light from the seat belt.

### ADVANTAGEOUS EFFECTS OF INVENTION

According to the invention, when the seat belt is imaged by the infrared camera, the contrast between the infrared light absorption regions and the other regions becomes clear.

### BRIEF DESCRIPTION OF DRAWINGS

FIG. 1 is a front view of a seat belt device according to an embodiment.

FIG. 2 is a top view of the seat belt device according to the embodiment.

FIG. 3 is a perspective view of a webbing according to the embodiment.

FIG. 4 is an enlarged top view of the webbing according to the embodiment.

FIG. 5 is a perspective view of the webbing according to another embodiment.

### DESCRIPTION OF EMBODIMENTS

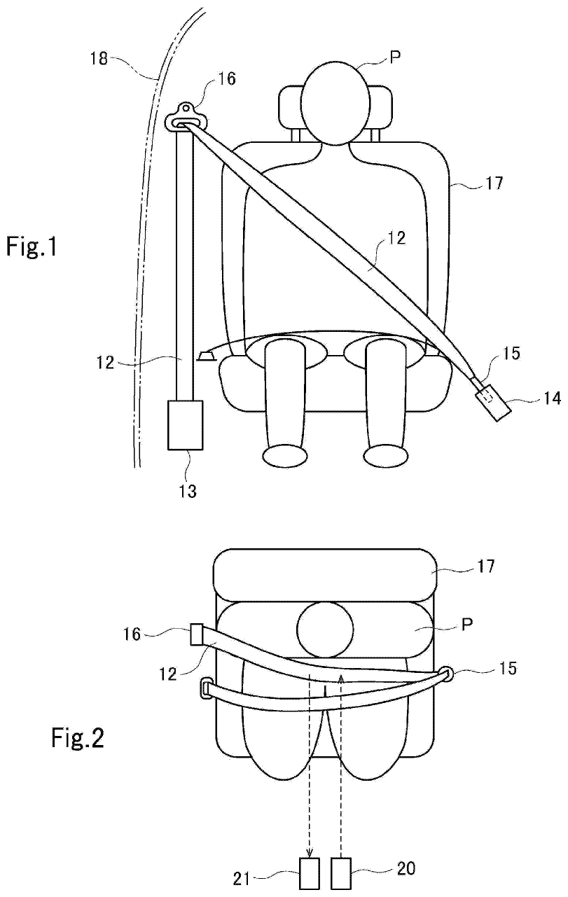

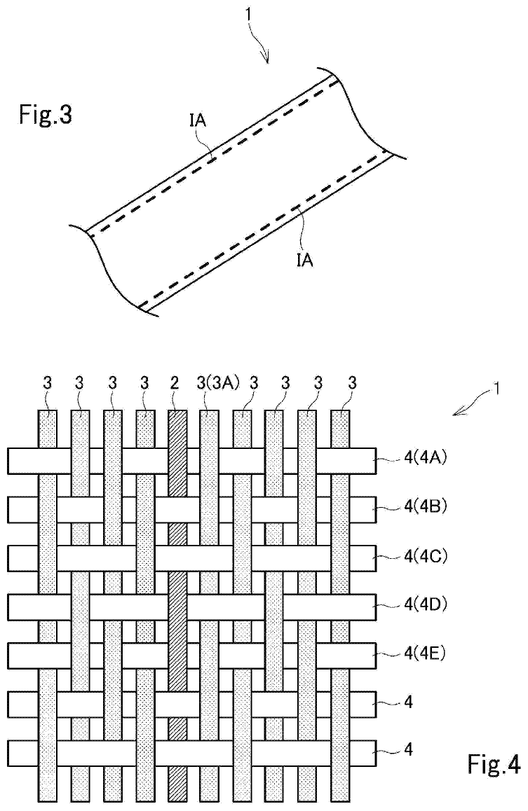

Embodiments of the invention will be described below with reference to the drawings. FIG. 1 is a front view of a seat belt device according to an embodiment. FIG. 2 is a top view of the seat belt device. FIG. 3 is a perspective view of a webbing. FIG. 4 is an enlarged top view of the webbing.

The seat belt device includes a seat belt 12, a retractor 13 on which the seat belt 12 is wound such that one side thereof is drawn out, a buckle 14 that is fixed to a vehicle 18, a tongue 15 that is slidably formed on the seat belt 12 and engages with the buckle 14, and a shoulder anchor 16 through which the seat belt 12 passes.

The seat belt device includes an irradiation unit 20 and a light receiving unit 21 which are provided in a vehicle cabin. The irradiation unit 20 emits infrared light toward the center in a width direction of a seat 17. The light receiving unit 21 receives infrared light reflected by an occupant P, the seat belt 12, and the like. As the light receiving unit 21, an infrared camera such as a CMOS camera for infrared light can be used. For example, the irradiation unit 20 and the light receiving unit 21 are provided in front of or provided diagonally in front of the occupant P seated on the seat 17.

The light receiving unit 21 generates image information according to the received reflected infrared light and transmits the image information to a control device (not shown).

The seat belt 12 includes infrared light absorption regions IA (see FIG. 3) that absorb infrared light. The infrared light absorption regions IA absorb almost 100% of infrared light and do not generate the reflected light of infrared light. Therefore, the control device can perform image processing on the image information received from the light receiving unit 21 and discriminates the infrared light absorption regions IA from the other regions. The control device can determine whether the seat belt 12 is properly worn according to the position, shape, and the like of the infrared light absorption regions IA in the image.

Next, a webbing 1 constituting the seat belt 12 will be described. The webbing 1 is fabric in which warp and weft yarns are woven so as to extend orthogonally to each other, and is woven in the form of a 2/2 twill weave, for example. At least one of a plurality of warp yarns is an infrared light absorption yarn 2, and the other warp yarns are normal yarns 3. The infrared light absorption yarn 2 is a yarn that absorbs almost 100% of infrared light and does not generate reflected light of infrared light. On the other hand, the normal yarns 3 are yarns having a lower infrared light absorptance than the infrared light absorption yarn 2 and hardly absorb infrared light, for example.

The infrared light absorption yarn 2 is obtained by applying an infrared light absorption dye (or an infrared light absorption pigment) to a multifilament yarn in which polyester fibers and nylon fibers are twisted together and converged or by immersing the multifilament yarn into the dye. The thickness (fineness) of the infrared light absorption yarn 2 containing the infrared light absorption dye (or infrared light absorption pigment) is about 300 to 3000 D. The normal yarns 3 are a multifilament yarns in which polyester fibers or nylon fibers are twisted together and converged, and are thinner than the infrared light absorption yarn 2 and have a thickness (fineness) of about 250 to 2000 D. As weft yarns 4, the same material as that of the normal yarns 3 can be used.

In the example shown in FIG. 4, the warp yarns (the infrared light absorption yarn 2 and the normal yarns 3) repeatedly passes over two weft yarns 4 and then passes below two weft yarns 4. For example, a normal yarn 3A passes over the weft yarns 4A and 4B and passes below the weft yarns 4C and 4D. After passing over the weft 4A, the infrared light absorption yarn 2 passes below the weft yarns 4B and 4C and over the wefts 4D and 4E, respectively.

The infrared light absorption yarn 2 passes over the weft yarns 4 at regular intervals. That is, in the webbing 1, the surface of the infrared light absorption yarn 2 is exposed at regular intervals. The exposed surface of the infrared light absorption yarn 2 is the infrared light absorption regions IA described above.

In the image information obtained by the light receiving unit 21, the infrared light absorption regions IA linearly appears along a longitudinal direction of the seat belt 12 (webbing 1). When the seat belt 12 is imaged by an infrared camera, the contrast between the infrared light absorption regions and the other regions becomes clear.

In this way, by weaving the warp yarns including the infrared light absorption yarn and producing the webbing 1, the infrared light absorption regions can be provided in the seat belt 12.

In the example shown in FIG. 3, the infrared light absorption regions IA are provided along the longitudinal direction of the webbing 1 and at both end portions in a transverse direction of the webbing 1, but the position of the infrared light absorption regions IA is not limited thereto, and may be provided, for example, in the center portion in the transverse direction of the webbing 1.

In the example shown in FIG. 4, only one infrared light absorption yarn 2 extends, but a plurality of infrared light absorption yarns 2 may be arranged side by side. One or more infrared light absorption yarns 2 and one or more normal yarns 3 may be alternately arranged. Further, all of the warp yarns may be used as the infrared light absorption yarns 2.

A webbing may also be produced by using an infrared light absorption yarn as a weft yarn.

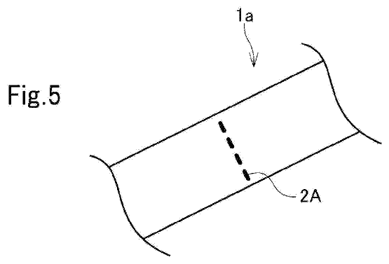

As shown in FIG. 5, after a webbing la is produced using all of the warp and weft yarns as the normal yarns, an infrared light absorption yarn 2A may be sewn to the webbing 1a. However, when the infrared light absorption yarn is woven in as a warp yarn or a weft yarn, the surface flatness of the webbing is high and the tactile sensation is good.

After the webbing is produced using all of the warp and weft yarns as the normal yarns, the infrared light absorption dye (or infrared light absorption pigment) may be applied to the surface of the webbing, or the webbing may be immersed into the infrared light absorption dye (or infrared light absorption pigment).

The invention is not limited to the embodiments described above and can be modified in various manners in practice without departing from the gist of the invention. Furthermore, various aspects of the invention can be formed through an appropriate combination of a plurality of components disclosed in the above-described embodiments. For example, some of the components shown in the embodiments may be omitted. Furthermore, components across different embodiments may be combined appropriately.

This application is based on Japanese Patent Application 2017-035011 filed on Feb. 27, 2017, which is incorporated by reference in its entirety.

### REFERENCE SIGNS LIST

1, 1a webbing
2, 2A infrared light absorption yarn
3 normal yarn
4 weft yarn
12 seat belt
13 retractor
14 buckle
15 tongue
16 shoulder anchor
17 seat
18 vehicle
20 irradiation unit
21 light receiving unit

1. An occupant restraint belt webbing forming a long occupant restraint belt to restrain a vehicle occupant, comprising:
a plurality of warp yarns and a plurality of weft yarns that are woven so as to extend orthogonally to each other, wherein
the warp yarns or the weft yarns include an infrared light absorption yarn.

2. The occupant restraint belt webbing according to claim 1, wherein
the infrared light absorption yarn is a filament yarn containing an infrared light absorption dye or an infrared light-absorbing pigment and made of polyester or nylon, and
among the warp yarns and weft yarns, the yarns other than the infrared light absorption yarn are filament yarns made of polyester or nylon.

3. The occupant restraint belt webbing according to claim 1, wherein
at least one of the plurality of warp yarns is the infrared light absorption yarn.

4. A seat belt as the occupant restraint belt formed using the occupant restraint belt webbing according to claim 1.

5. A seat belt device comprising:
the seat belt according to claim 4;
a retractor that is configured to wind the seat belt;
a buckle that is fixed to a vehicle;
a tongue that is provided on the seat belt and that engages with the buckle;
an irradiation unit that is configured to irradiate the seat belt with infrared light; and
a light receiving unit that is configured to receive reflected light from the seat belt.
